(19) United States
(12) Patent Application Publication
(10) Pub. No.: US 2024/0408976 A1
(43) Pub. Date: Dec. 12, 2024

(54) Method for Operating a Drive Axle for a Motor Vehicle, Control Unit, Drive Axle, and Motor Vehicle

(71) Applicant: Bayerische Motoren Werke Aktiengesellschaft, Muenchen (DE)

(72) Inventor: Martin KOERBER, Neufahrn (DE)

(21) Appl. No.: 18/699,746

(22) PCT Filed: Oct. 25, 2022
(86) PCT No.: PCT/EP2022/079682

§ 371 Date: Apr. 9, 2024

(30) Foreign Application Priority Data
Dec. 1, 2021 (DE) 10 2021 131 522.0

(51) Int. Cl. B60L 15/20

(52) U.S. Cl. CPC B60L 15/2054; B60L 2240/461; B60L 2240/486; B60L 2240/50

(57) ABSTRACT

A method for operating a drive axle, a control unit for carrying out the method, a drive axle, and a motor vehicle. In the method, a driving state variable is detected which characterizes the current driving situation. A coupling probability value K is ascertained on the basis of the driving state variable, and if the coupling probability value K is greater than a threshold G, the rotational speed of the transmission output element is adapted to a wheel driveshaft rotational speed via an electric traction machine. The process of adapting the rotational speed is carried out in a predictive manner, i.e. regardless of whether a coupling process is subsequently initiated in which the transmission output element and the wheel driveshaft are rotationally fixed to each other.

### BACKGROUND AND SUMMARY

The present disclosure relates to a method for operating an at least partially electrically driveable drive axle designed for a motor vehicle. In addition, the disclosure relates to a control unit configured to perform steps of the method. Moreover, the disclosure relates to a drive axle comprising such a control unit. Furthermore, the disclosure relates to an at least partially electrically driveable/movable motor vehicle, in particular an automobile and/or a truck. The motor vehicle comprises such a drive axle. The motor vehicle may be, for example, a hybrid motor vehicle that comprises both an internal combustion engine and at least one electric drive unit. Further, the motor vehicle may be a purely electrically driveable motor vehicle (“electric car”) that is free of an internal combustion engine.

To maximize the efficiency of drivetrains of at least partially electrically driveable or movable motor vehicles, these can be equipped with a so-called decoupling unit that can be used, while the vehicles are in motion, to decouple, that is to say shut down, an electric machine and/or parts of the respective drivetrain in a manner appropriate to the situation, or according to need, so as to minimize frictional losses occurring during operation of the drivetrain. Such decoupling is employed in particular in motor vehicles that have more than one drive unit, for instance an internal combustion engine and an electric machine (hybrid motor vehicle) or more than one electric machine (purely electrically driveable motor vehicle), and in each case, in the drive unit that facilitates all-wheel drive in the coupled state.

DE 20 2011 109 790 U1 discloses a drivetrain for a purely electrically all-wheel-operable motor vehicle. The drivetrain can comprise two electric machines, one of which is decouplable via a switchable clutch. Moreover, DE 102 19 080 A1 discloses a drive system that comprises an electric machine arranged so as to be disconnectable from the drivetrain by way of one or two clutches. Further, DE 101 48 088 B4 discloses a motor vehicle that comprises a clutch, in particular in the form of a friction clutch, via which a drive motor is disconnectable from a gear, for instance, for starting the vehicle or for carrying out switching processes.

An overall time requirement for coupling or recoupling is made up, inter alia, of electronic signal propagation times, times for condition plausibility checking (for example via an electronic controller), a time for synchronizing speeds of the elements to be coupled to one another, a time for mechanically moving coupling elements of the decoupling unit, and a time for increasing the torque after coupling. Normally, the process of speed synchronization takes place only after the decoupling unit has been provided with a control signal for starting the coupling process by the motor vehicle, for instance the controller. Moreover, conventional decoupling units of electrically driveable motor vehicles are known to operate with positive-engagement and/or friction coupling elements. Positive-engagement coupling requires speed synchronization between the elements that have been shut down and the rotating elements that are intended to be coupled to one another, so that malfunctions during the coupling process can be avoided. If friction coupling elements are used, speed synchronization is likewise beneficial in order to keep wear on the friction coupling elements as low as possible. This speed synchronization process decisively determines a time requirement for the overall coupling process according to the power of the electric motor, the mass moments of inertia of the rotating parts involved, and the required synchronization speed. The prior art thus has the problem that recoupling takes place particularly slowly. This manifests itself for example when a driver of an appropriately equipped motor vehicle requests a high drive power, this request for power being met by virtue of the electric motor being (re) coupled into the drivetrain. The driver then experiences a delay between submission of the request for power (for example, a pedal fully depressed) and the actual velocity-increasing acceleration of the motor vehicle, because the time requirement for coupling or recoupling the electric machine is disadvantageously particularly high. This could unsettle the driver and induce said driver, for example during the delay, to further intensify the submission of the request for power, which would lead to excessive acceleration, which was thus not expected by the driver to that extent, after coupling is complete.

The object of the present disclosure is to provide a way of being able to reversibly couple an electric machine into a drivetrain of a motor vehicle particularly efficiently, in particular quickly, and in a manner appropriate to the situation, or according to need.

The disclosure proposes a method for operating a drive axle for a motor vehicle. In the intended installation position of the drive axle, the motor vehicle comprises the drive axle, and so the drive axle forms part of the motor vehicle. The motor vehicle is, for example, an automobile and/or truck, the motor vehicle being of at least partially electrically driveable or movable design by virtue of it comprising the drive axle. Accordingly, the drive axle is a purely electric drive axle or is a hybrid drive axle. At any rate, the drive axle comprises an electric traction machine and a gear device. A rotor shaft of the electric traction machine and a gear drive element of the gear device are non-rotatably connected to one another here.

“Non-rotatably connected to one another” or the like is intended herein to be understood to mean that a relative rotation of elements involved in this non-rotatable connection in relation to one another is disabled. In this respect, two ring gears, which mesh with one another/into one another, for example, are also deemed non-rotatably connected to one another herein.

The gear device further comprises a gear output element connected or connectable to the gear drive element by way of a transmission mechanism of the gear device. The transmission mechanism may be in the form of a single-stage or multistage transmission mechanism. Further, the transmission mechanism may be of automatically or manually switchable or—for instance in the case of an input gear-non-switchable design.

The drive axle further comprises a wheel drive shaft and a coupling device, the gear output element and the wheel drive shaft being—for the purpose of speed and/or torque transmission-wholly or partially couplable to one another via the coupling device and—for the purpose of decreasing, in particular canceling, the torque transmission-wholly or partially decouplable from one another. The coupling device is, for example, a positive-engagement or friction coupling device. In the case of a friction coupling device, the gear output element and the wheel drive shaft can be partially decoupled from another, or partially coupled to one another, by virtue of slippage being permitted via the friction coupling device.

In an alternative embodiment, the coupling device may be positioned elsewhere, for instance between the gear device and the differential, between the rotor shaft and the gear device, etc. In addition, it is conceivable for the coupling device to be in the form of part of the transmission mechanism, for instance in the form of a gear switching element. Further, the coupling device may be in the form of a part of the differential.

An outer, or lateral, end of the wheel drive shaft has a wheel (a tire/rim combination) non-rotatably mounted on it-directly or indirectly—that, at least when the wheel drive shaft and the gear output element are non-rotatably coupled to one another via the coupling device, is driveable via the electric traction machine. If the gear output element and the wheel drive shaft are decoupled from one another via the coupling device, then-depending on where or between which elements of the drive axle the coupling device is arranged-more or fewer elements of the drive axle are driven by the rotating wheels.

The drive axle of the motor vehicle may be in the form of a main drive axle or in the form of an auxiliary drive axle. If the drive axle is in the form of the auxiliary drive axle, the auxiliary drive axle can be used, in the intended installation position, in conjunction with a main drive axle of the motor vehicle to provide an all-wheel-drive functionality for the motor vehicle. This means that in this case the motor vehicle comprises the drive axle in the form of the auxiliary drive axle and at least one further drive axle, specifically the main drive axle. If, on the other hand, the drive axle is in the form of the main drive axle and the motor vehicle comprises no other drive axle, the motor vehicle is driveable only by way of the drive axle—that is to say that the motor vehicle then has just front-wheel drive or just rear-wheel drive.

The method for operating the drive axle involves using a first method step to predictively—that is to say independently of whether a coupling process in which the gear output element and the wheel drive shaft are non-rotatably coupled to one another is actually subsequently started-record at least one driving condition variable that characterizes a current driving situation of the motor vehicle comprising the drive axle. Another predictive method step then comprises—for example a control unit-taking the at least one driving condition variable as a basis for ascertaining a coupling probability value K. This coupling probability value K expresses the level of a probability of the coupling process in which the gear output element and the wheel drive shaft are non-rotatably coupled to one another actually being started or performed in the current driving situation, or on the basis of the current driving situation, or on the basis of a current change of driving situation. In other words, the coupling probability value K expresses how probable it is that an actuator of the coupling device will actually be sent, for example via the control unit, a control signal that is accepted by the coupling device as an input control signal, the coupling device then being used to non-rotatably couple the wheel drive shaft and the gear output element to one another. The intended understanding herein is thus that the coupling process is deemed to have actually been started only when the applicable control signal has been sent to the coupling device, or to the actuator thereof, and/or only when the actuator actually becomes or has become mechanically active.

If the coupling probability value K is greater than or at least equal to the limit value G, the electric traction machine is used to match a speed of the gear output element to a speed of the wheel drive shaft, that is to say to a wheel drive shaft speed. This can be accomplished using the control unit, for example, which can be used to control or actuate the electric traction machine. To put it another way, the control unit can be used to control or regulate a speed of the rotor shaft, that is to say a rotor shaft speed of the electric traction machine, in such a way that the gear ratios of the transmission mechanism can be taken into consideration for matching the rotor shaft speed to the wheel drive shaft speed. Once this matching process has taken place, the rotor shaft of the electric traction machine and consequently the gear drive element rotate at a synchronization speed that is transmitted via the transmission mechanism in such a way that the gear output element and the wheel drive shaft rotate or are rotated in the same sense and at the same speed.

The coupling probability value K can be indicated in percent, for example, and so the coupling probability value K can assume values between 0 (0%) and 1 (100%). If a coupling process is 70% probable, the coupling probability value K is then 0.7, or 70%. The limit value G of the coupling probability value K can be stipulated as 0.5, for example, and so the speed of the gear output element is matched to the wheel drive shafts of the speed if the coupling probability value is equal to 0.5 or greater than 0.5. It goes without saying that the limit value G can be stipulated as another value when the drive axle, or the control unit, is manufactured. Further, it is conceivable for the limit value G to be adjustable in a limited range of adjustment or between 0 and 1.

As a result of the speeds of the wheel drive shaft and the gear output element thus being predictively performed—that is to say independently of whether the coupling process is actually started after the speeds are matched—the drive axle is put into a condition in which, after the control signal has been delivered, for example via the control unit, the coupling process, that is to say the mechanical coupling of the wheel drive shaft to the gear output element, takes place particularly quickly. The reason is that, instead of synchronizing the speeds of the wheel drive shaft and the gear output element only when the need for the electric traction machine to be coupled or recoupled into the remainder of the drivetrain has been determined, the speed of the gear output element and the wheel drive shaft speed are predictively aligned with one another in accordance with the method proposed herein, in particular, even before the need for the actual mechanical coupling has been determined or ascertained. The electric traction machine and/or other elements of the drive axle, for instance at least parts of the gear device, can thus be (re) activated particularly easily after they/it has/have previously been shut down. If the motor vehicle comprises the drive axle described herein as its only drive axle, for example, it is thus possible to change back over to an overrun mode—for example after a coasting mode-particularly quickly, in the coasting mode being particularly efficient due to the electric traction machine having been shut down and/or due to the parts of the gear device having been shut down, as these are not driven by way of the wheels of the motor vehicle and therefore do not produce frictional losses.

In one development of the method, a first driving condition variable, for which the coupling probability value K is greater than the limit value G, is stored, for example via the control unit. A variance value A is then ascertained that characterizes a variance, or a difference, between the first driving condition variable and a second driving condition variable, the second driving condition variable being recorded in up-to-date fashion after the first driving condition variable. If this variance value A is less than a predefined or predefinable variance limit value AG, the speed of the gear output element is matched to the wheel drive shaft speed. This can be performed in particular repeatedly (multiple times), in particular continually, resulting in adaptive learning. Quite generally, it is ascertained in which driving situations (under what torque, at what velocity, for what wheel slippage, etc.) the coupling process was actually started in the past. In light of this/these past, first driving situation(s), the current (second) driving situation approaching the past, or first, driving situation(s) can result in relationships being predictively formed with such parameters, similarly to adaptive gear control. It is said: “The vehicle gets to know the driver better and better.”

This comparison between the first driving condition variable and the second driving condition variable, or the corresponding driving situations, can take place as an alternative or in addition to the ascertainment of the coupling probability value K. By way of example, the comparison of the first driving condition variable and the second driving condition variable can be performed as a plausibility check prior to ascertainment, during the ascertainment, or after the ascertainment of the coupling probability value K. This allows the coupling probability value K to be ascertained particularly reliably, as a result of which unintentional or unnecessary matching of the speeds of the wheel drive shaft and the gear output element occurs particularly rarely. This leads to particularly energy-efficient operation of the drive axle and consequently of the motor vehicle equipped with the drive axle.

In another embodiment of the method, the current, or second, driving condition variable is recorded by recording one or more of the following driving condition subvariables:
a deflection of a pedal (e.g., a “gas pedal”), that is to say a request for power submitted by a user or driver of the motor vehicle,
a history of deflections of the pedal over time,
a history of instances of a predefined or predefinable limit position of the pedal being exceeded over time,
a coefficient of friction of a road surface ahead or currently traveled on (dry, moisture, film of standing water, ice, snow, gravel, oil spill, unconsolidated, etc.),
a gradient of a road ahead or currently traveled on,
a route planning that, for example, has been input into a navigation system of the motor vehicle by the driver and/or is anticipated by the navigation system automatically (that is to say without the involvement of the driver, or without a route planning having been input),
an operating condition of a direction of travel indicator, in particular in conjunction with data provided via the navigation system, for example based on the route planning,
an operating condition of a safety system of the drive axle or of the motor vehicle, for example an automatic antilocking system, an electronic stability program (ESP), in particular with a trailer stability assist system, a traction control system, etc.

Recording the deflection of the pedal or the history of deflections of the pedal over time allows a preferred driving style of the driver of the motor vehicle to be inferred, for example. Further, the deflection of the pedal, or the history of the pedal deflections, can be taken as a basis for inferring whether a power-intensive driving maneuver is intended by the driver, for instance an overtaking maneuver. Recording the history of the instances of the limit position of the pedal being exceeded over time allows, inter alia, it to be inferred that there is an uneven road surface necessitating imminent use of the all-wheel-drive functionality. The limit position of the pedal may be, for example, a kick down operation threshold of the pedal and/or another predefined or predefinable operation threshold/limit position of the pedal. Recording the coefficient of friction and/or the gradient of the road ahead or currently traveled on likewise contributes to efficiently assessing whether more drive power and/or traction is required that can be provided by coupling the electric traction machine into the remainder of the drivetrain. The route planning can be input into the navigation system by the driver. Alternatively, or additionally, the navigation system can be used, for instance by virtue of its evaluating digital map material, to automatically anticipate a route or a route section ahead without the driver having actively input their destination. By recording this route planning—in particular in conjunction with an evaluation of a current operating condition of a direction of travel indicator—it is possible to infer a turning maneuver, in particular with subsequent high drive torque requirement, for instance when entering a freeway or another fast road. In this case, the maximum drive power is advantageously available as soon as the driver of the motor vehicle accelerates the motor vehicle in a highly velocity-increasing manner by operating the pedal to enter the freeway. If at least one of the safety systems of the motor vehicle and/or the drive axle is currently in a normal mode, it may likewise be or become necessary for the electric traction machine to be coupled into the remainder of the drivetrain for slowing or acceleration purposes, for example in order to accelerate/slow down in an axle- and/or wheel-selective manner.

Recording the driving condition variable or driving condition variables allows the coupling probability value K to be ascertained particularly precisely, with the result that the current driving situation can be taken as a basis for coupling the gear output element to the wheel drive shaft particularly quickly in a manner appropriate to the situation and according to need. In particular with respect to the at least one safety system or driving stability system, the fast or quick coupling of the electric traction machine into the remainder of the drivetrain increases a control speed and/or a control quality of the applicable system, contributing to a particularly high level of road safety. According to one development of the method, the respective driving condition subvariable is recorded using a sensor system—for example, a sensor system that is used in the motor vehicle anyway. Alternatively, or additionally, the respective driving condition subvariable is recorded using a navigation system of the motor vehicle. As such, for example, the sensor system is used to record the current driving condition, and an applicable sensor value is taken as a basis for providing the corresponding driving condition variable. Sensors of the sensor system that are used to record the respective driving condition subvariable are, for example, a velocity sensor, a wheel speed sensor, an acceleration sensor, a temperature sensor, a camera sensor, a laser sensor, a lidar sensor, etc. Road data, for example, the gradient, a curve profile, etc., can be recorded using the navigation system. Owing to the sensor system and/or the navigation system being used in the motor vehicle anyway, a respective dual functionality is advantageously obtained, since it is possible to dispense with a separate sensor system and/or with a separate navigation system for performing the method.

Another embodiment of the method provides for-when the coupling process is or has been started—the wheel drive shaft and the gear output element to be coupled to one another with positive engagement via the coupling device. In other words, the coupling device comprises at least one positive-engagement coupling unit or is in the form of the positive-engagement coupling unit. The positive-engagement coupling unit may be, for example, a dog clutch, a tooth clutch, etc. In particular, there is provision for the coupling device to be free of a friction coupling unit, that is to say, for example, free of a friction disk clutch, etc. This effectively avoids frictional losses between the wheel drive shaft and the gear output element.

In another embodiment of the method-if the speed of the gear output element has been predictively matched to the wheel drive shaft speed and the coupling process is not subsequently started—the gear output element is slowed, in particular slowed to a standstill, in a regenerative mode of the electric traction machine. On account of the regenerative mode of the electric traction machine, an electrical energy store of the drive axle or of the motor vehicle comprising the drive axle is provided here with electrical energy via the electric traction machine. Thus, should the performance of the method result in the coupling probability value K greater than the limit value G being ascertained, and in the electric traction machine then being used to predictively match the speed of the gear output element to the wheel drive shaft speed, the associated energy consumption can be compensated for at least in part by virtue of the subsequent active slowing of the gear output element driving the electric traction machine in regenerative mode until the gear output element and consequently the rotor shaft of the electric traction machine are idle again. The method is therefore particularly energy efficient.

The disclosure also relates to a control unit for the drive axle of the motor vehicle, designed according to the above description. The control unit is configured here to carry out method steps of the method designed according to the above description—in particular all method steps of the applicable method—and to use the method steps to control, or actuate, the electric traction machine of the drive axle and/or the coupling device. Accordingly, the control unit and also the electric traction machine and/or the coupling device are coupled or couplable to one another in such a way that the electric traction machine and/or the coupling device can be provided with control signals via the control unit. The electric traction machine is designed here to accept the control signals of the control unit as input control signals.

Further, the disclosure relates to a drive axle for a motor vehicle, designed according to the above description and operable, or controllable, or actuable, using a method outlined in the above description. To this end, the drive axle comprises the control unit designed according to the above description.

In another embodiment, the drive axle is in the form of an auxiliary drive axle that can be used, in the intended installation position, in conjunction with a main drive axle of the motor vehicle to provide an all-wheel-drive functionality for the motor vehicle. In this way, coupling the electric traction machine into the remainder of the drivetrain according to need, or in a manner appropriate to the situation, can be used to selectively activate or deactivate an all-wheel drive of the motor vehicle. This activation or deactivation of the all-wheel drive takes place particularly quickly using the method described above.

Finally, the disclosure additionally relates to a motor vehicle, for example a hybrid motor vehicle or a purely electrically driveable or movable motor vehicle, that comprises the drive axle designed according to the above description. In particular, the drive axle is in the form of the auxiliary drive axle, meaning that the motor vehicle comprises at least one further driveable or driven axle. If the motor vehicle is driven both via the drive axle and via the at least one further axle while in motion, the motor vehicle has—at least in this operating mode-multi-axle drive, in particular all-wheel drive.

Further features of the disclosure may arise from the claims, the figures and the description of the figures. The features and combinations of features cited hereinbefore in the description, and the features and combinations of features shown hereinafter in the description of the figures, and/or in the figures alone, can be used not only in the respectively indicated combination, but also in other combinations, or on their own, without departing from the scope of the disclosure.

### BRIEF DESCRIPTION OF THE DRAWINGS

FIG. 1 shows a schematic or topological view of a drive axle for a motor vehicle, comprising a coupling device via which an electric traction machine of the drive axle and parts of a gear device of the drive axle are deactivated;

FIG. 2 shows a schematic or topological view of the drive axle, the coupling device being used to couple a wheel drive shaft and a gear output element to one another;

FIG. 3 shows a schematic or topological view of the drive axle, the coupling device being used to couple the wheel drive shaft and the gear output element to one another; and,

FIG. 4 shows a flowchart to illustrate method steps of a method for operating the drive axle.

In the figures, identical and functionally identical elements are provided with the same reference signs.

### DETAILED DESCRIPTION OF THE DRAWINGS

The text below provides a joint description of a method for operating a drive axle 1, a control unit 2, the drive axle 1 per se, and a motor vehicle 3 comprising the drive axle 1. The drive axle 1 in the present example is in the form of an auxiliary drive axle 4, the drive axle 1, that is to say the auxiliary drive axle 4, being part of the motor vehicle 3 when in the intended installation position. The motor vehicle 3 is indicated in the figures but not depicted fully. The motor vehicle 3 is in particular in the form of an automobile and comprises the drive axle 1, or auxiliary drive axle 4, and additionally at least one further drive axle (not depicted). The drive axle 1, or auxiliary drive axle 4, in combination with the further drive axle, is used to provide an all-wheel-drive functionality of the motor vehicle 3. This means that when the drive axle 1, or auxiliary drive axle 4, is activated, the motor vehicle 3 has multi-axle, in particular all-wheel, drive. When the drive axle 1 is not used to provide the motor vehicle 3 with drive power, the motor vehicle 3 has just rear-wheel drive or just front-wheel drive.

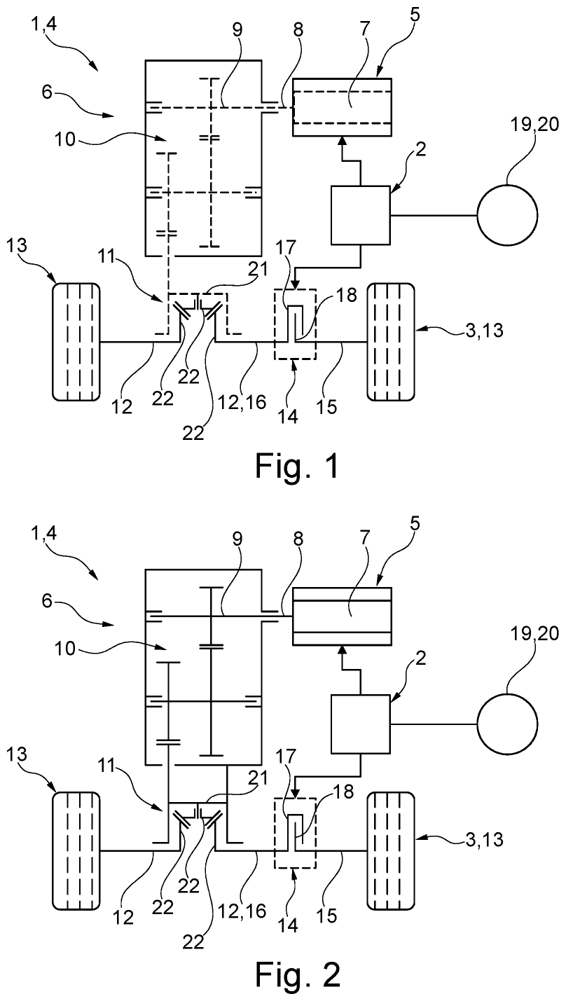

The drive axle 1, or auxiliary drive axle 4, comprises an electric traction machine 5 and a gear device 6. A rotor 7 of the electric traction machine 5 and therefore a rotor shaft 8 of the electric traction machine 5 and a gear drive element 9, in the present case a gear drive shaft, are non-rotatably connected to one another. The gear device 6 further comprises a transmission mechanism 10 and a differential 11, which is in the form of a bevel gear differential in the present example. The transmission mechanism 10 can be used to non-rotatably connect the rotor shaft 8 and output elements 12 of the differential 11 to one another, and in the present example, it has been used to connect them to one another. The respective output element 12 is, for example, a respective output shaft of the differential 11. One of the output elements 12, or one of the output shafts of the differential 11, is non-rotatably connected directly to one of the wheels 13 (tire/rim combination) of the motor vehicle 3. The applicable output element 12, which is depicted on the left in FIG. 1 in the present example, thus forms a wheel drive shaft of the drive axle 1, or of the motor vehicle 3, which is non-rotatably connected to the wheel 13 (depicted on the left in FIG. 1) of the motor vehicle 3, or of the drive axle 1. The other of the output elements 12, or the other of the output shafts of the differential 11, is selectively non-rotatably connectable to a wheel drive shaft 15 of the wheel 13 depicted on the right in FIG. 1 via a coupling device 14. This means that the drive axle 1, or the motor vehicle 3 comprising the drive axle 1, comprises the coupling device 14. The coupling device 14 is movable here between a coupling position and a decoupling position. Further, the coupling device 14—provided that it is in the form of a friction coupling device—can be moved into at least one slipping position. In the coupling position, the wheel drive shaft 15 and a gear output element 16, which is formed by the applicable output element 12 of the differential 11, are non-rotatably connected to one another, and so a relative rotation between the wheel drive shaft 15 and the gear output element 16, or the applicable output element 12, is disabled. By contrast, in the decoupling position of the coupling device 14, a relative rotation between the wheel drive shaft 15 and the gear output element 16 is enabled. To put it another way: the coupling device 14 can be used to non-rotatably couple the gear output element 16 of the gear device 6 and the wheel drive shaft 15 to one another or to decouple them from one another. If the coupling device 14 is in the form of a positive-engagement coupling device, the gear output element 16 and the wheel drive shaft 15 are selectively non-rotatably couplable to one another or decouplable from one another. In the slipping position, speed and/or torque is transferred between the gear output element 16 of the gear device 6 and the wheel drive shaft 15, a relative rotation between the gear output element 16 and the wheel drive shaft 15 being permitted to a certain degree.

In an alternative embodiment, the coupling device 14 may be arranged at a different point on the drive axle 1, for instance between the gear device 6 and the differential 11, between the rotor shaft 8 and the gear device 6, etc. In addition, it is conceivable for the coupling device 14 to be in the form of part of the transmission mechanism 10, for instance in the form of a gear switching element (not depicted). Further, the coupling device 14 may be in the form of a part of the differential 11.

In the present example, the coupling device 14 is in the form of a positive-engagement coupling unit, meaning that a first coupling element 17 and a second coupling element 18 of the coupling device 14 impart a positive engagement between one another when the coupling device 14 is moved from the decoupling position into the coupling position.

In the present example, the motor vehicle 3, in particular the drive axle 1 thereof, moreover comprises the control unit 2 and also a sensor system 19. The control unit 2 is configured, or set up, to carry out method steps, in particular all method steps, of the method for operating the drive axle 1 that is described more thoroughly below. To this end, the control unit 2 is coupled or couplable to the electric traction machine 5 and/or to the coupling device 14, the electric traction machine 5 and/or the coupling device 14 being designed to accept control signals of the control unit 2 as input control signals. In other words, there is provision in the present example for the electric traction machine 5 and/or the coupling device 14 to be actuable or controllable via the control unit 2.

The sensor system 19 is in particular in the form of a sensor system of the motor vehicle 3, the motor vehicle 3 comprising the sensor system 19 anyway independently of the drive axle 1. In addition, the motor vehicle 3, in particular the drive axle 1 thereof, comprises a navigation system 20, the sensor system 19 and/or the navigation system 20 being connected or connectable to the control unit 2. This allows a value ascertained via the sensor system 19 (sensor value) and/or data from the navigation system 20 to be delivered to the control unit 2 for electronic further processing.

FIG. 1 uses broken lines to indicate that the rotor 7 and elements of the gear device 6 that are connected thereto are free of speed and torque, meaning that the elements depicted in broken lines in FIG. 1 are idle or deactivated. This means that in this condition the wheels 13 are passively pulled or pushed while the motor vehicle 3 is in motion. In order to now switch the electric traction machine 5 (back) into the remainder of the drivetrain particularly efficiently, in particular quickly, the method for operating the drive axle 1 involves using a first method step S1 (see FIG. 4) to predictively—that is to say independently of whether the coupling device 14 is moved from the decoupling position into the coupling position, as a result of which the wheel drive shaft 15 and the gear output element 16 are non-rotatably coupled to one another-record a driving condition variable that characterizes a current driving situation of the motor vehicle 3, in particular of the drive axle 1. A further method step S2 is then used to ascertain a coupling probability value K on the basis of the driving condition variable recorded in method step S1. In the present example, the driving condition variable is recorded using the sensor system 19 and/or the navigation system 20. By way of example, the sensor system 19 and/or the navigation system 20 is/are used to provide the control unit 2 with a sensor and/or navigation value that is subjected to computing operations via the control unit 2, the result of said computing operations governing the coupling probability value K. To this end, the control unit 2 may comprise a computer device (e.g., a controller, processor, CPU, microcontroller, etc.) that executes software, or a program code, stored in a memory (e.g., RAM, ROM, hard disk, etc.) as a result of which the coupling probability value K is ascertained on the basis of the sensor or navigation value.

A further method step S3 is used to check whether the coupling probability value K is greater than or at least equal to a predefined or predefinable limit value G. If method step S3 yields the result that the coupling probability value K is greater than the limit value G, method step S3 is followed by a further method step S4, in which the electric traction machine 5 is used to match a speed of the gear output element 16 to a speed of the wheel drive shaft 15. Should performance of method step S3 produce the result that the coupling probability value K is less than the limit value G, on the other hand, method step S3 may be followed by method step S1, for example.

The speed of the gear output element 16 and the speed of the wheel drive shaft 15 are matched via the electric traction machine 5 by virtue of the latter being actuated—in particular via the control unit 2—in such a way that the rotor shaft 8 rotates or is rotated at a synchronization speed, and this synchronization speed being transmitted via the transmission mechanism 10—in particular in combination with the differential 11—in such a way that the speed of the gear output element 16 and the wheel drive shaft speed are or become identical.

As is evident from the description above, the movement of the coupling device 14 from the decoupling position thereof into the coupling position thereof, that is to say the coupling process, has not yet been initiated, or started. Rather, the speed of the gear output element 16 is matched to the speed of the wheel drive shaft 15 predictively—that is to say independently of whether the coupling process is actually started after the speed of the gear output element 16 has been matched to the wheel drive shaft speed. To start the coupling process, that is to say to move the coupling device 14 into the coupling position, the present example requires a control signal, which is delivered to the coupling device 14 via the control unit 2, for example. While this control signal is absent or has not been delivered to the coupling device 14, the coupling process is deemed not to have been started (yet) herein. If the coupling device 14 comprises an actuator for moving between the decoupling position and the coupling position, for example, the speed of the gear output element 16 is matched to the wheel drive shaft speed before the coupling device 14, in particular the actuator thereof, actually becomes mechanically active.

FIG. 2 shows a schematic or topological view of the drive axle 1, the coupling device 14 being used to couple the wheel drive shaft 15 and the gear output element 16 to one another. This is accomplished by virtue of the electric traction machine 5 being actuated via the control unit 2 in a speed control mode in such a way that the rotor shaft 8 rotates or is rotated at the synchronization speed, as a result of which the transmission mechanism 10 and the differential 11, in particular the cage 21 thereof, are driven. The synchronization speed is transmitted here via the transmission mechanism 10 such that the gear output element 16 rotates or is rotated at the same speed and in the same direction of rotation as the wheel drive shaft 15. Consequently, the coupling elements 17, 18 rotate at the same speed and in the same direction, with the result that the two coupling elements 17, 18 can be combined with one another in order to form the positive engagement between one another. By way of example, the coupling elements 17, 18 are moved toward one another, as a result of which the coupling elements 17, 18 engage in one another and this results in the positive engagement being produced. When FIG. 2 and FIG. 1 are viewed together, it becomes clear that the transmission mechanism 10 and the cage 21 of the differential 11 and also bevel gears 22 of the differential 11 are rotating or being driven, this being illustrated by the solid representation of each of the applicable elements in FIG. 2.

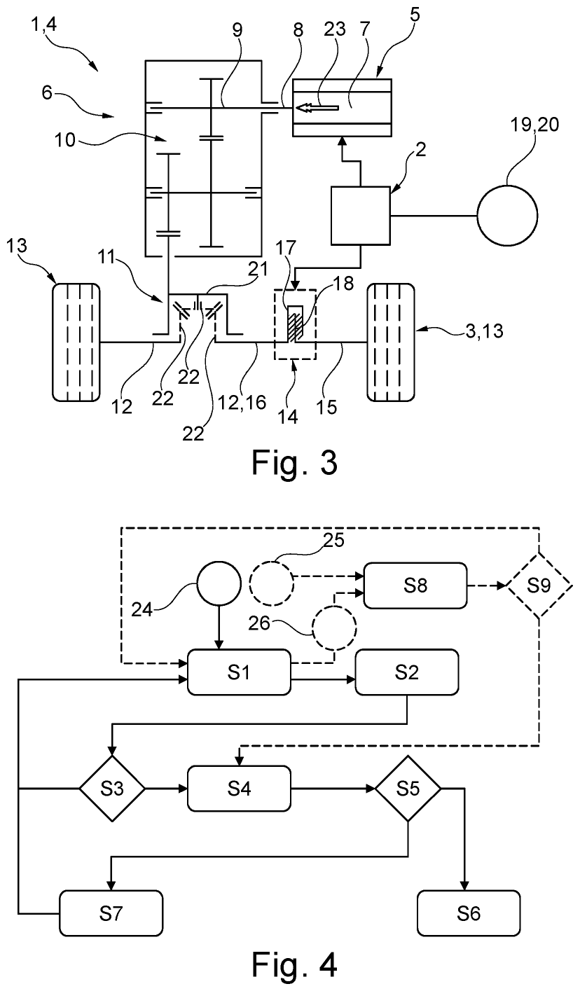

FIG. 3 shows a schematic or topological view of the drive axle 1, the coupling device 14 having been used to non-rotatably couple the wheel drive shaft 15 and the gear output element 16 to one another. It can be seen that the positive engagement is formed between the coupling elements 17, 18. In addition, it can be seen that the bevel gears 22 of the differential 11 are not rotating or are idle. It should be understood that the bevel gears 22 do rotate when the drive axle 1, or the accordingly equipped motor vehicle 3, travels through a curve. In addition, the electric traction machine 5 is changed over from the speed control mode to a torque control mode, for example via the control unit 2, with the result that the electric traction machine 5 is used to deliver a torque 23 to the wheels 13.

FIG. 4 shows a flowchart to illustrate method steps of the method for operating the drive axle 1, it being possible to see that a further method step S5 is used to check whether the coupling process has actually been started after method step S4, that is to say after the speed of the gear output element 16 has been matched to the wheel drive shaft speed via the electric traction machine 5. In other words, method step S5 is used to check whether the control unit 2 has been used to deliver the control signal for moving the coupling device 14 from the decoupling position thereof into the coupling position thereof, and/or whether the actuator of the coupling device 14 actually becomes, or has become, mechanically active. If it is ultimately determined in method step S5 that the coupling process has taken place, with the result that the coupling elements 17, 18 have been combined with one another in such a way that the positive engagement is formed between the coupling elements 17, 18, method step S5 is followed by a further method step S6, in which the electric traction machine 5 is changed over from the speed control mode to the torque control mode. In addition, method step S6 comprises the delivery of the torque 23 via the electric traction machine 5.

If, on the other hand, performance of method step S5 ultimately determines that the control unit 2 has not delivered the control signal required for moving the coupling device 14, method step S5 is followed by a further method step S7, in which the electric traction machine 5 is switched to a regenerative operating mode and, as a result, the gear output element 16 is actively slowed by way of the differential 11 and by way of the transmission mechanism 10. In this case, the electric traction machine 5 is used to provide an electrical energy store of the drive axle 1, or of the motor vehicle 3, with electrical energy. In other words, method step S7 is used to at least partially recover energy that has been used to accelerate the gear output element 16 to the speed corresponding to the wheel drive shaft speed, provided that the coupling device 14 is not moved into the coupling position after this speed adjustment. Once the regeneration process is complete in method step S7, for example, when the gear output element 16, or the rotor shaft 8, has been slowed to a standstill, method step S7 may be followed by method step S1, for example.

Method step S6 may be followed by a decoupling process in which the electric traction machine 5 is actuated via the control unit 2 in such a way that the coupling elements 17, 18 are arranged without tension in relation to one another, meaning that the positive engagement between the coupling elements 17, 18 can be easily canceled. This is the case when the traction machine 5 is not used to deliver driving and slowing torque for driving or slowing the wheels 13; so-called zero torque control is performed. In addition, the electric traction machine 5 is switched from the torque control mode to the speed control mode before the coupling device 14 is moved into the decoupling position thereof, with the result that all elements of the drive axle 1 that are involved in a torque transmission become torque-free relative to one another. Once this condition has been reached, the coupling device 14—which can also be referred to as a DCU (Disconnect Clutch Unit)—is opened, or moved into the decoupling position. In this condition, it is then made possible, for example, to shut down, in particular completely switch off, the electric traction machine 5, which includes switching off an inverter of the electric traction machine 5, for example. The condition of the drive axle 1 that is depicted in FIG. 1 and in parts of the description that pertain to FIG. 1 has therefore been reached. The cage 21 of the differential 11 is idle, the output element of the output elements 12 that is depicted on the left being driven via the wheel 13 depicted on the left as a result of the drive axle 1 being passively pushed or pulled, the wheels 13 running on a road surface. The bevel gears 22 of the differential 11 rotate, and so the output element 12 depicted on the left and the output element 12 depicted on the right rotate in opposite senses in plan view, as a result of which the coupling elements 17, 18 rotate in opposite senses, or are rotated in opposite senses.

Reference is again made to the flowchart of FIG. 4, in which it can be seen that to perform method step S1, that is to say to record the driving condition variable, data 24 of the sensor system 19 and/or of the navigation system 20 act as input values. These data are, for example, driving condition subvariables that at least partially characterize the respective driving situation, or the respective driving condition. In other words, the driving condition variable may be formed by one or more of the following driving condition subvariables:
a deflection of a pedal,
a history of deflections of the pedal over time,
a history of instances of a predefined or predefinable limit position of the pedal being exceeded over time,
a coefficient of friction of a road surface ahead or currently traveled on,
a gradient of a road ahead or currently traveled on,
a route planning that, for example, has been input into the navigation system 20 by the driver and/or is anticipated by the navigation system 20 automatically (that is to say without the involvement of the driver, or without a route planning having been input),
an operating condition of a direction of travel indicator,
an operating condition of a safety system, in particular driver assistance system or driving stability system.

The flowchart of FIG. 4 additionally uses broken lines to depict method parts of the method for operating the drive axle 1 that are able to be performed as an alternative or in addition to method steps S1 to S7 described previously. A further method step S8 is depicted, which is provided with a first driving condition variable 25, for which the coupling probability value K is greater than the limit value G. This means that this first driving condition variable 25 was stored, for example via the control unit 2 (e.g., in the memory), in the past in order to perform method step S8. The first driving condition variable 25 is thus a past driving condition variable. In addition, method step S8 is provided with a second driving condition variable 26 in order to perform it, this second driving condition variable 26 being the driving condition variable that is or was recorded in method step S1 prior to method step S8 being performed. By way of example, there may be provision for the driving condition variable recorded in method step S1 to be stored in the drive axle 1, or in the motor vehicle 3, in particular in the control unit 2, for later/new use, in particular in method step S8. Method step S8 is then used to ascertain a variance value A that characterizes a variance between the first driving condition variable 25 and the second driving condition variable 26. A further method step S9, which follows method step S8, is then used to check whether the variance value A is less than a predefined or predefinable variance limit value AG. If the result available after method step S9 has been performed is that the variance value A is less than the variance limit value AG, the speed of the gear output element 16 is predictively matched to the wheel drive shaft speed. In other words-if the variance value A is less than the variance limit value AG-method step S9 is followed by method step S4 being performed. If, on the other hand, the result of method step S9 is that the variance value A is greater than or at least equal to the variance limit value AG, method step S9 may be followed by method step S1, for example.

The method for operating the drive axle 1 for the motor vehicle 3, the control unit 2, the drive axle 1 per se, and the motor vehicle 3 demonstrate a respective way of allowing an electric machine, for example the electric traction machine 5, to be reversibly coupled into a drivetrain particularly efficiently and in particular quickly in a manner appropriate to the situation, or according to need.

### LIST OF REFERENCE SIGNS

1 drive axle
2 control unit
3 motor vehicle
4 auxiliary drive axle
5 electric traction machine
6 gear device
7 rotor
8 rotor shaft
9 gear drive element
transmission mechanism
11 differential
12 output element
13 wheel
14 coupling device
wheel drive shaft
16 gear output element
17 coupling element
18 coupling element
19 sensor system
navigation system
21 cage
22 bevel gear
23 torque
24 data
25 first driving condition variable
26 second driving condition variable
A variance value
AG variance limit value
G limit value
K coupling probability value
S1 method step
S2 method step
S3 method step
S4 method step
S5 method step
S6 method step
S7 method step
S8 method step
S9 method step

1.-10. (canceled)

11. A method for operating a drive axle for a motor vehicle, in which a rotor shaft of an electric traction machine and a gear drive element of a gear device are non-rotatably connected to one another, a gear output element of the gear device and a wheel drive shaft being couplable to one another and decouplable from one another via a coupling device, the method comprising:
recording a driving condition variable that characterizes a current driving situation, the driving condition variable being taken as a basis for ascertaining a coupling probability value K and,
using the electric traction machine to match a speed of the gear output element to a wheel drive shaft speed, if the coupling probability value K is greater than a limit value G, independently of whether a coupling process is subsequently started in which the gear output element and the wheel drive shaft are non-rotatably coupled to one another.

12. The method according to claim 11, wherein:
a first driving condition variable, for which the coupling probability value K is greater than the limit value G, is stored, and a variance value A is ascertained between the first driving condition variable and a second driving condition variable, which is recorded in up-to-date fashion after the first driving condition variable, and, if the variance value A is less than a variance limit value AG, the speed of the gear output element is matched to the wheel drive shaft speed.

13. The method according to claim 11, wherein:
the driving condition variable is recorded by recording one or more of the following driving condition subvariables:
a deflection of a pedal,
a history of deflections of a pedal over time,
a history of instances of a limit position of a pedal being exceeded over time,
a coefficient of friction of a road surface,
a gradient of a road,
a route planning,
an operating condition of a direction of travel indicator,
an operating condition of a safety system.

14. The method according to claim 13, wherein:
the driving condition subvariable is recorded using a sensor system and/or a navigation system.

15. The method according to claim 11, wherein:
when the coupling process is started, the wheel drive shaft and the gear output element are coupled to one another with positive engagement via the coupling device.

16. The method according to claim 11, wherein:
if the speed of the gear output element has been matched to the wheel drive shaft speed and the coupling process is not subsequently started, the gear output element is slowed in a regenerative mode of the electric traction machine, wherein an electrical energy store is provided with electrical energy via the electric traction machine.

17. A control unit for a drive axle of a motor vehicle, the control unit being configured to carry out the method according to claim 11 to control an electric traction machine and a coupling device of the drive axle.

18. A drive axle for a motor vehicle, said drive axle being able to be operated using the control unit according to claim 17.

19. The drive axle according to claim 18, wherein:
the drive axle is in the form of an auxiliary drive axle that can be used, in the intended installation position, in conjunction with a main drive axle of the motor vehicle to provide an all-wheel-drive functionality.

20. A motor vehicle having a drive axle according to claim 18.
